(19) United States
(12) Patent Application Publication
(10) Pub. No.: US 2026/0251426 A1
(43) Pub. Date: Aug. 27, 2026

(54) PEEP SIGHT HAVING TWO LENSES

(71) Applicant: Specialty Archery, L.L.C., Spencer, IA (US)

(72) Inventor: Andrew Pauley, Wahpeton, IA (US)

(21) Appl. No.: 19/545,486

(22) Filed: Feb. 20, 2026

Related U.S. Application Data
(60) Provisional application No. 63/761,451, filed on Feb. 21, 2025.

(51) Int. Cl. F41G 1/467; F41G 11/00; G02B 7/02

(52) U.S. Cl. CPC F41G 1/467; F41G 11/004; G02B 7/021; G02B 7/022

(57) ABSTRACT

A peep sight assembly includes a housing having a first end and an opposing second end and defines a passage therethrough. The passage has first and second threads at the first and second ends of the housing. The peep sight assembly also includes a first aperture configured to be connected to the first end of the housing. The first aperture includes first threads for being received by the first threads at the first end of the housing, a first lens receiver for receiving a first lens, and an annular finger grip. The peep sight assembly further includes a second aperture configured to be connected to the second end of the housing. The second aperture includes second threads for being received by the second threads at the second end of the housing, a second lens receiver for receiving a second lens, and an annular finger grip.

### CROSS-REFERENCE TO RELATED APPLICATIONS

The present application claims the benefit under 35 U.S.C. § 119(e) of U.S. Provisional Application Ser. No. 63/761,451, filed Feb. 21, 2025, and titled “PEEP SIGHT HAVING TWO LENSES,” which is herein incorporated by reference in its entirety.

### BACKGROUND

Peep sights used in archery are aiming devices contributing to the enhancement of the skills of the archer. Peep sights are typically mounted on the bowstring above the nocking point so that upon drawing the bowstring back, the archer may align with one eye the small bore of the peep sight with a bow sight pin and a target. The locating of a target and the sighting on the target through a constricted, small-diameter peep sight is difficult to locate and to orient the peep sight bore in the registry with the intended precise field of interest. Also, even the slightest misalignment of the bore of the peep sight with a line of sight of the archer on the sight pin and target tends to render the effort very difficult to view through the peep sight bore to sight the target.

### DRAWINGS

The Detailed Description is described with reference to the accompanying figures. The use of the same reference numbers in different instances in the description and the figures may indicate similar or identical items.

FIG. 1 is a first end elevation view illustrating a peep sight including a housing and first and second apertures in accordance with example embodiments of the present disclosure.

FIG. 2 is a second end elevation view of the peep sight illustrated in FIG. 1.

FIG. 3 is a first plan view of the peep sight illustrated in FIG. 1.

FIG. 4 is a second plan view of the peep sight illustrated in FIG. 1.

FIG. 5 is an isometric view of the peep sight illustrated in FIG. 1.

FIG. 6 is a cross-sectional side elevation view of the peep sight illustrated in FIG. 1.

FIG. 7 is a perspective view of the peep sight illustrated in FIG. 1, where the first and second apertures are shown partially unthreaded from the housing.

FIG. 8 is an exploded perspective view of the peep sight illustrated in FIG. 1.

FIG. 9 is another exploded perspective view of the peep sight illustrated in FIG. 1.

FIG. 10 is an exploded side view of the peep sight illustrated in FIG. 1.

FIG. 11 is an exploded cross-sectional plan view of the peep sight illustrated in FIG. 1.

FIG. 12 is an exploded cross-sectional perspective view of the peep sight illustrated in FIG. 1.

FIG. 13 is an exploded isometric view illustrating a peep sight having a number of interchangeable apertures, where each one of the interchangeable apertures has a different aperture size in accordance with example embodiments of the present disclosure.

FIG. 14 is an end view of the peep sight and interchangeable apertures illustrated in FIG. 13.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Farsightedness is a vision problem in which the ability to see objects in the distance is normal, but objects that are close appear blurred to the viewer. Nearsightedness is a vision problem in which objects in the distance appear blurred to the viewer, but objects that are close appear normal.

Peep sights have been developed to carry a very small lens (0.5 millimeters in diameter) within the peep. The variety and power of available lenses to the archer are quite numerous. Bright surrounding environments and dark surrounding environments may require the interchange of the lens to a different power as the pupil dilates. Additionally, the archer can use a verifier lens to help clear up the sight pins of the bowstring, making them more distinct. However, the verifier lens makes the target appear hazy or fuzzy. When using a magnified scope lens in the bow scope, the archer can also use a clarifier lens that cleans up the target, enhancing clarity for the target image. The higher the bow scope, the blurrier the target is. If the archer uses a high clarifier power, it makes the bow scope's pins blurry while having a clear target. Therefore, the archer has the option of using a clarifier lens to improve target visibility or using a verifier lens to enhance pin clarity, depending on their specific needs.

Described herein is a double lens peep sight assembly for archery. The peep sight assembly includes apertures that apertures that can be removably coupled on both sides of the housing, such as by threaded engagement, allowing an archer to custom fit the peep hole to an individual's scope housing size and draw length. The peep sight assembly also includes two lenses, e.g., where one lens is a clarifier lens, and the other lens is a verifier lens. The peep sight assembly can be used with no lenses, one clarifier, one verifier, or with both a verifier and a clarifier.

In some embodiments, the apertures can be removably coupled to the housing using threaded engagement. In other embodiments, the apertures can be coupled to the housing using other mechanical retention mechanisms, including but not limited to press-fit engagement, snap-fit engagement, bayonet-style connections, frictional engagement, or combinations thereof, such that an aperture can be retained with respect to the housing to position the lenses at respective ends of the housing.

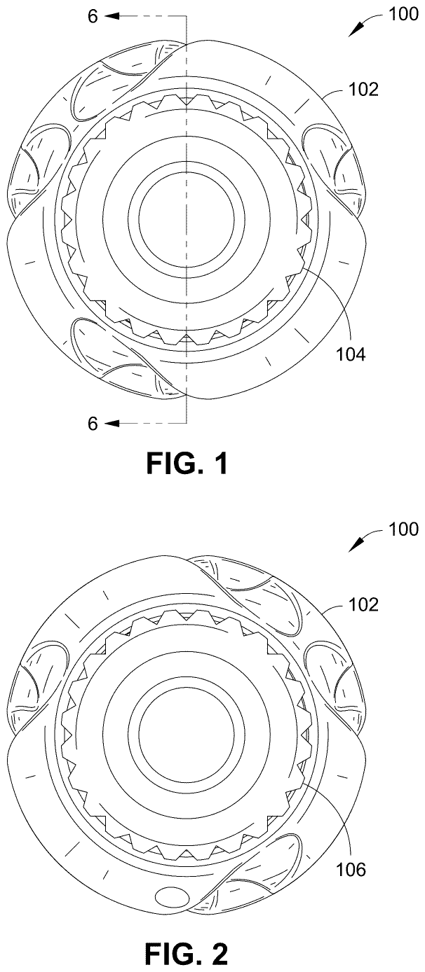

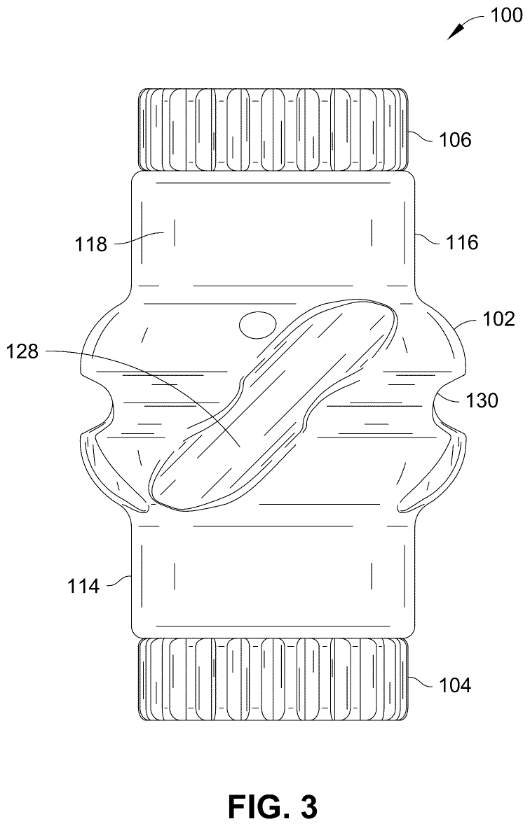

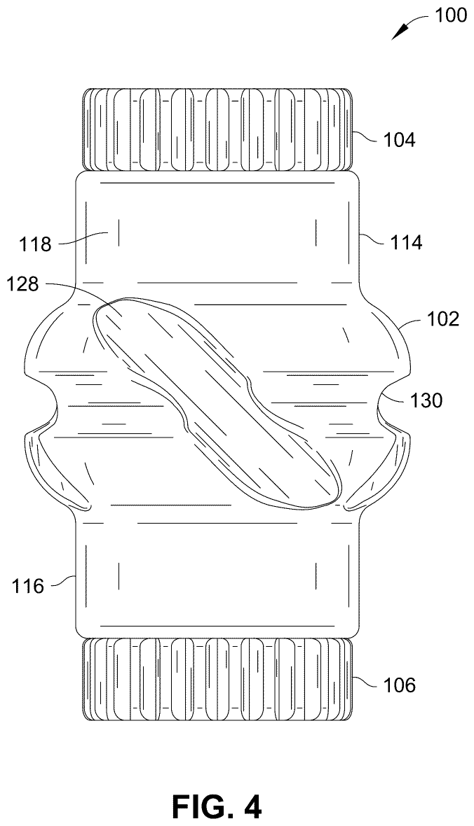

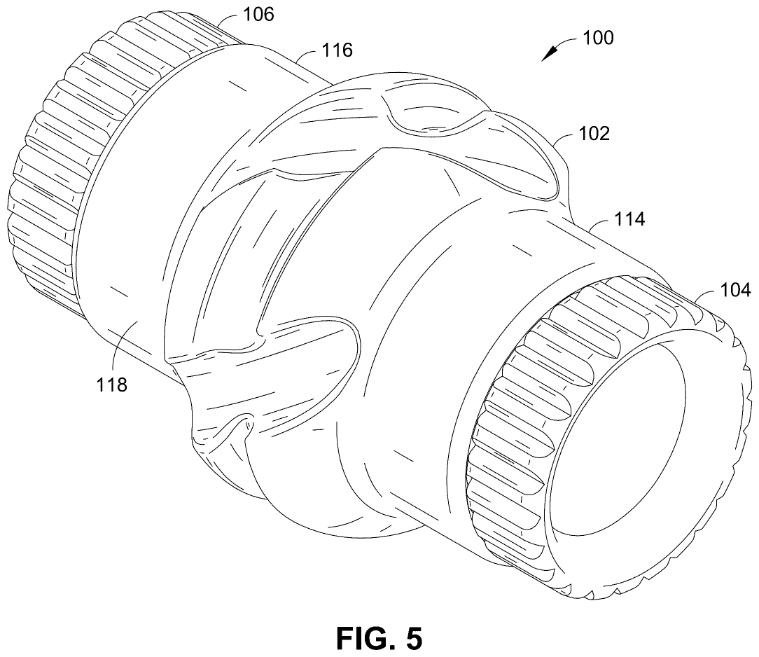

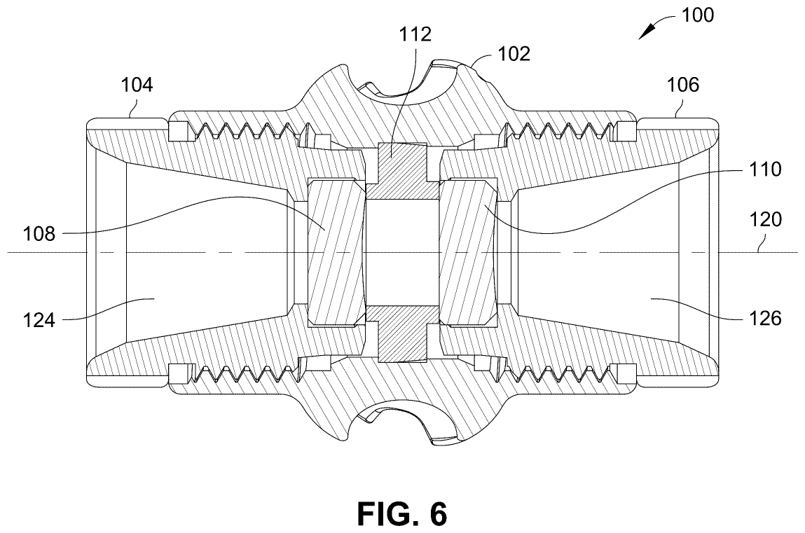

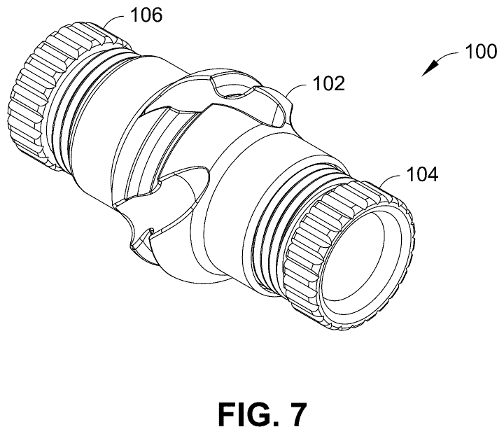

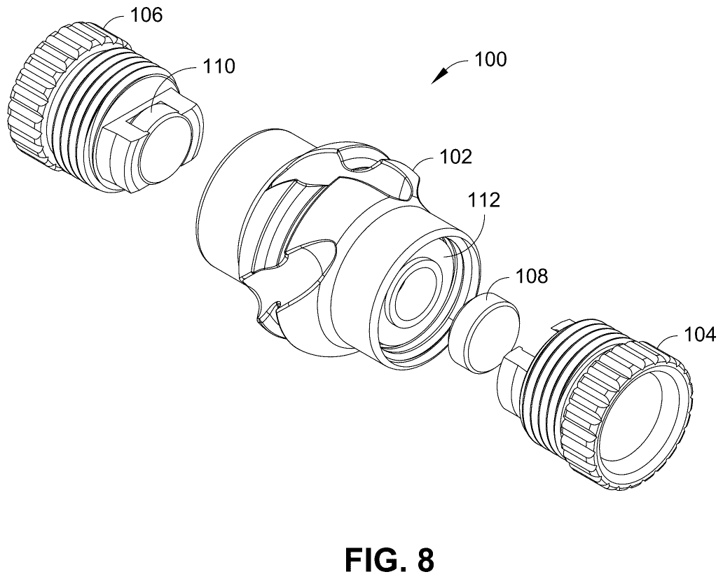

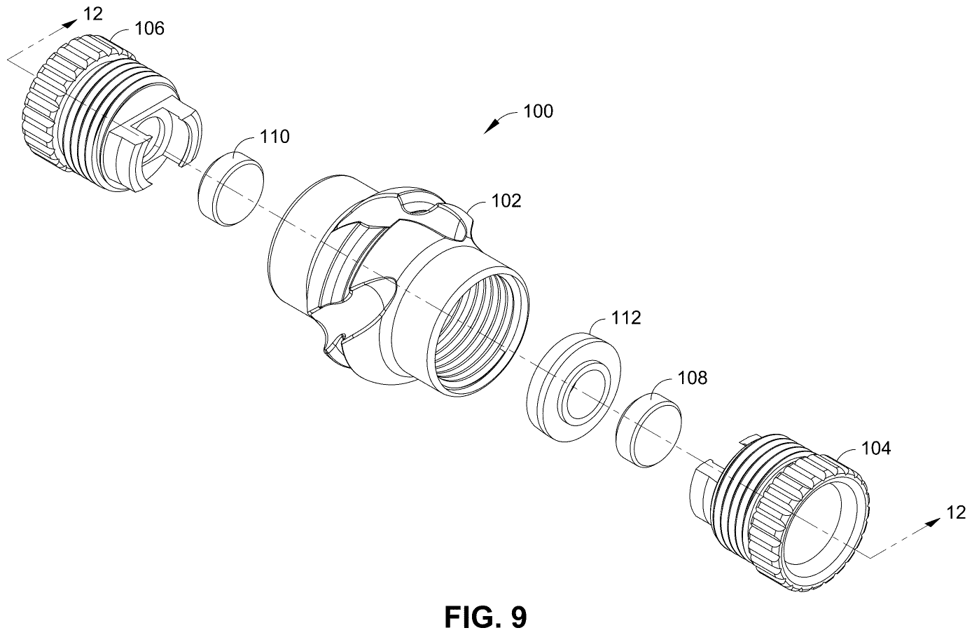

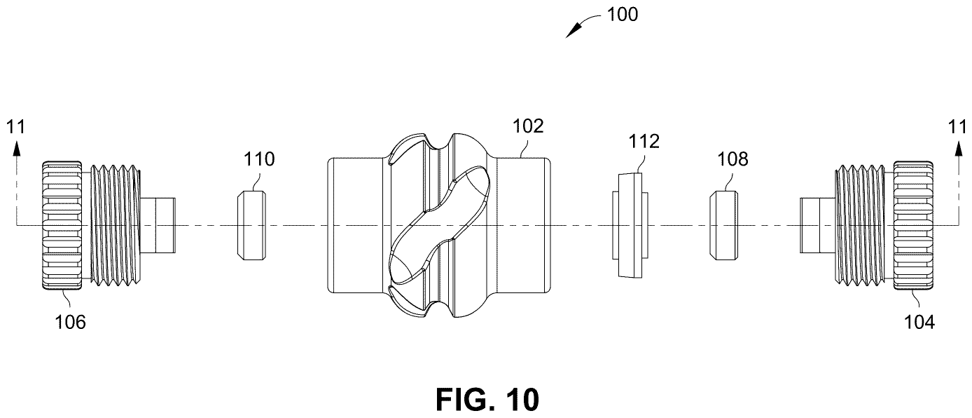

Referring generally to FIGS. 1 through 20, peep sight assemblies 100 for connecting to the bowstring of an archery bow are described. A peep sight assembly 100 includes a housing 102, a first aperture 104, a second aperture 106, a first lens 108, a second lens 110, and a lens insulator 112. In embodiments, the housing 102 has a generally cylindrical geometry and is centrally hollow. Additionally, the housing 102 can be made of a light, resistant material, such as aluminum or plastic. The housing 102 includes a first end 114, a second end 116 that is opposite to the first end 114, and an external surface 118. In some embodiments, the first end 114 of the housing 102 is facing the bow sight and target and the second end 116 of the housing 102 is facing the archer's eye. The housing 102 is defined by an axis 120 (e.g., as described with reference to FIG. 6) and includes an internal first passage 122 that is co-axial with respect to the axis 120 of the housing 102. The first aperture 104 is configured to be connected to the first end 114 of the housing 102. The first aperture 104 defines an internal second passage 124 therethrough. Similarly, the second aperture 106 is configured to be connected to the second end 116 of the housing 102 and defines an internal third passage 126 therethrough.

In embodiments, the housing 102 includes external grooves 128 defined on two opposite lateral sides of the external surface 118 of the housing 102. Additionally, the housing 102 can include a string channel 130 that is concentrically located with respect to the axis 120 and the first passage 122 of the housing 102. The external grooves 128 are for seating the housing 102 between a separated section of the bowstring of the archery bow above the knock. The housing 102 can be secured in place by a serving string anchored in the string channel 130, so that the peep sight assembly 100 can be secured to the bowstring.

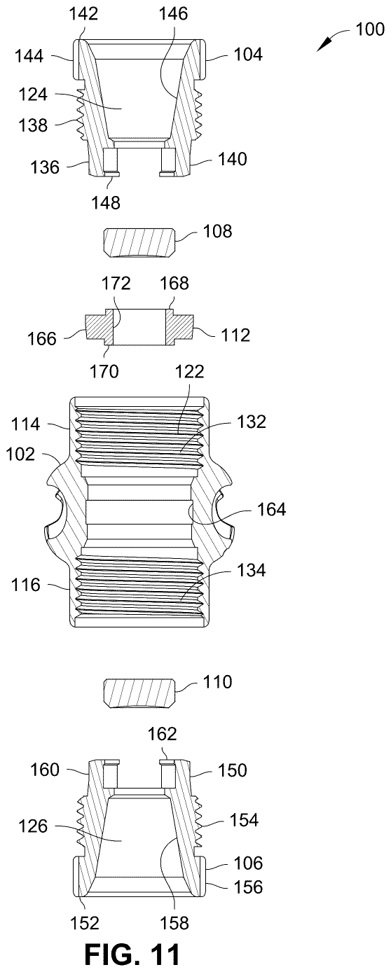

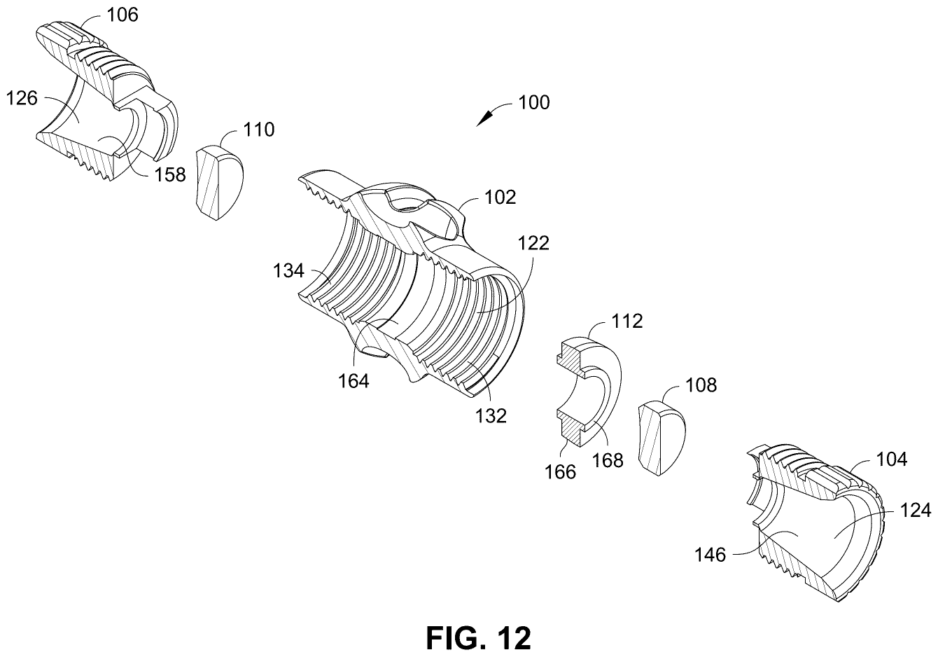

As described, the first passage 122 extends from the first end 114 of the housing 102 all the way through the second end 116 of the housing 102. The first passage 122 includes internal front threads 132 at the first end 114 of the housing 102 and internal rear threads 134 at the second end 116 of the housing 102. With reference to FIG. 11, the first aperture 104 includes a first end 136 having first external threads 138 and a lens receiver 140. The first aperture 104 also includes a second end 142 opposite to the first end 136. The second end 142 includes an annular finger grip 144. The front threads 132 of the housing 102 are configured to receive the first external threads 138 at the first end 136 of the first aperture 104 to connect the first aperture 104 to the housing 102 (e.g., rotatable engagement of the first aperture 104 and the housing 102). Additionally, the annular finger grip 144 of the second end 142 of the first aperture 104 assists in the engagement of the first aperture 104 and the housing 102 without any tools. The first aperture 104 limits bright light (e.g., sunlight) from entering the first passage 122 of the housing 102. As shown in FIGS. 11 and 12, the first aperture 104 has a frustoconical inner wall 146 that defines the internal second passage 124. As described, the lens receiver 140 can be positioned at the first end 136 of the first aperture 104 for receiving the first lens 108. In some embodiments, the lens receiver 140 has flexible lens retainers 148 or fingers which are L-shaped in cross section. The lens retainers 148 may be milled out of an inward facing annular lip (not shown). The lens retainers 148 are easily spreadable (e.g., with one or two fingernails) to remove the first lens 108 from the first aperture 104 for cleaning, replacement, utilization of a different lens or utilization of a lens with some special light enhancing coating.

With continuing reference to FIG. 11, the second aperture 106 includes a first end 150 and an opposing second end 152. The first end 150 of the second aperture 106 includes second external threads 154. The rear threads 134 of the housing 102 are configured to receive the second external threads 154 of the second aperture 106 to rotatably engage the second aperture 106 and the housing 102 and connect the second aperture 106 to the housing 102. The second end 152 of the second aperture 106 includes an annular finger grip 156 for assisting in the engagement of the second aperture 106 and the housing 102 without the use of any tools. As shown in FIGS. 11 and 12, the second aperture 106 has a frustoconical inner wall 158 that defines the internal third passage 126. The second aperture 106 also includes a lens receiver 160 located at the first end 150 of the second aperture 106 for receiving the second lens 110. In some embodiments, the lens receiver 160 has flexible lens retainers 162 or fingers which are L-shaped in cross section. The lens retainers 162 may be milled out of an inward facing annular lip (not shown). The lens retainers 162 are easily spreadable (e.g., with one or two fingernails) to remove the second lens 110 from the second aperture 106 for cleaning, replacement, utilization of a different lens or utilization of a lens with some special light enhancing coating.

It should be noted that while the front and rear threads 132 and 134 of the housing 102 and the first and second threads 138 and 154 of the respective first and second apertures 104 and 106 have been described with some specificity, these threaded embodiments are provided by way of example and are not meant to limit the present disclosure. In other embodiments, the apertures 104 and/or 106 can be removably coupled to the housing 102 using other retention mechanisms, including, but not necessarily limited to: press-fit engagement, snap-fit engagement, bayonet-style connections, frictional engagement, and so forth.

Referring again to FIGS. 11 and 12, the first passage 122 of the housing 102 can also have a reduced cross-sectional area 164 between the internal front threads 132 and the internal rear threads 134. The lens insulator 112 can be configured to be positioned between the first aperture 104 and the second aperture 106 in the reduced cross-sectional area 164 for securing the first lens 108 with respect to the first aperture 104 and/or the second lens 110 with respect to the second aperture 106. In some embodiments, the lens insulator 112 includes at least one outer annular retainer 166, lip or rim. When the lens insulator 112 is inserted into the first passage 122 from the first or second ends 114 or 116 of the housing 102, the annular retainer 166 snaps into the first passage's reduced cross-sectional area 164 thereby locking the lens insulator 112 in place. The lens insulator 112 may include a first annular support ring 168 for supporting the first lens 108 and a second annular support ring 170 for supporting the second lens 110 when the first lens 108 and the second lens 110 are in place. The lens insulator 112 can be hollow (e.g., defining a passage therethrough) and can have a cylindrical inner wall 172.

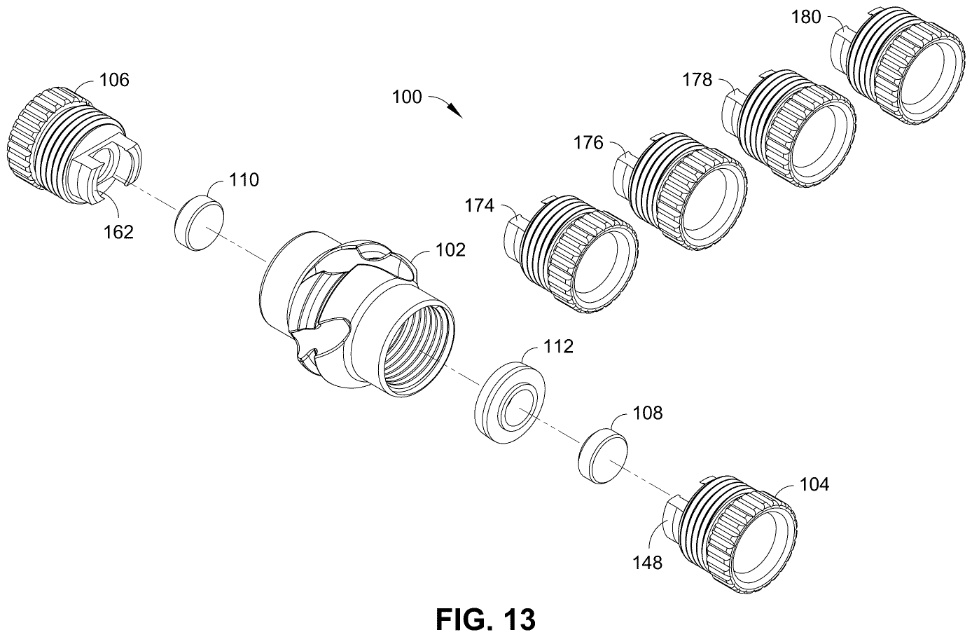

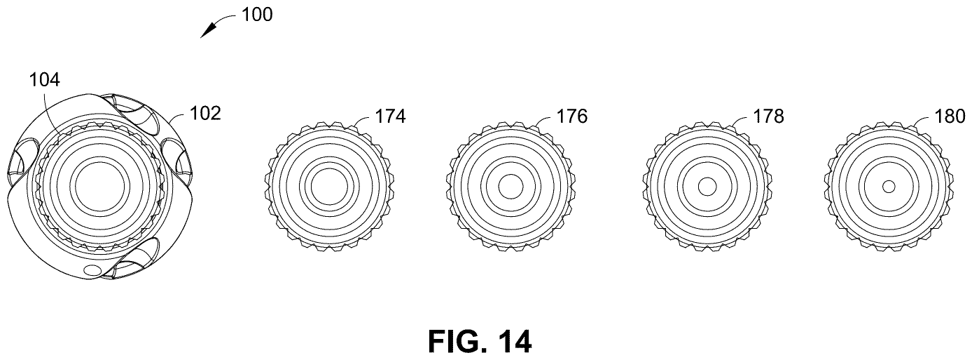

The assembly and operation of the peep sight assembly 100 will now be described. Initially, the archery bow is placed into a bow press to release bow string tension. The location for mounting the peep sight assembly 100 on the bow string is determined, the bow string is parted, and the housing 102 is mounted and tied into place on the bow string. As described, the lens insulator 112 can be positioned and secured within the reduced cross-sectional area 164 of the first passage 122 of the housing 102 e.g., by the manufacturer or the archer prior to assembly in some instances. As shown in FIGS. 13 and 14, the peep sight assembly 100 can be configured to be customized, allowing an archer to custom fit the peep hole to an individual's scope housing size and draw length. For example, an archer can choose different housing sizes, first apertures having varying aperture sizes, second apertures having varying aperture sizes, and so forth, e.g., depending on the archer's needs.

In some embodiments, a first aperture 104 having an opening with a diameter of about one-eighth of an inch (0.125″) can be interchanged with another first aperture 174 having an opening with a diameter of about three-thirty-seconds of an inch (0.093″), a different first aperture 176 having an opening with a diameter of about one-sixteenth of an inch (0.062″), another first aperture 178 having an opening with a diameter of about three-sixty-fourths of an inch (0.046″), an aperture 180 having an opening with a diameter of about one-thirty-second of an inch (0.031″), and so forth. Similarly, the second aperture 106 can be exchanged with other apertures having varying diameters, including, but not necessarily limited to the diameters described with respect to the first aperture 104. It should also be noted that the aperture diameters described herein are provided by way of example and are not meant to limit the present disclosure. Thus, other apertures having different diameters can be used with the peep sight assemblies 100 described herein. Further, in some embodiments the first aperture 104 and/or the second aperture 106 can have a variable (e.g., user adjustable) diameter opening.

The housing 102 is now positioned on the bow string and ready for further assembly. The archer selects the first lens 108 and the second lens 110 type and power appropriate for his or her condition (farsighted or nearsighted). If not already removed, the archer can remove the first aperture 104 from the housing 102 by simply turning the annular finger grip 144 of the first aperture 104. The archer can then insert the first lens 108 within the lens receiver 140 by simply forcing open the lens retainers 148. Thereafter, the first aperture 104 is threaded into the first end 114 of the housing 102 by turning the annular finger grip 144 so that the internal front threads 132 of the housing 102 and the first external threads 138 of the first aperture 104 can rotatable engage. In a similar fashion, the archer can remove the second aperture 106 from the housing 102 by simply turning the annular finger grip 156 of the second aperture 106. The archer can then insert the second lens 110 within the lens receiver 160 by simply forcing open the lens retainers 162. Thereafter, the second aperture 106 is threaded into the second end 116 of the housing 102 by turning the annular finger grip 156 so that the internal rear threads 134 of the housing 102 and the second external threads 154 of the second aperture 106 can rotatable engage. The lens insulator 112 is positioned between the first lens 108 and the second lens 110. Finally, the archer may adjust and practice the sighting in the bow.

In the field, if the first lens 108 become dirty and in need of cleaning, the archer simply removes the first aperture 104 without fear of the first lens 108 falling out of the peep sight assembly 100 which remains on the bow string. The archer may clean the first lens 108 while in place in the lens receiver 140 of the first aperture 104 as the first lens 108 is substantially exposed but still captured. Additionally, if the second lens 110 become dirty and in need of cleaning, the archer simply removes the second aperture 106 without fear of the second lens 110 falling out of the peep sight assembly 100 which remains on the bow string. The archer may clean the second lens 110 while in place in the lens receiver 160 of the second aperture 106 as the second lens 110 is substantially exposed but still captured. In some embodiments, the archer may simply pry open the lens retainers 148 and/or 162 of the lens receivers 140 and/or 160 of the first aperture 104 and/or the second aperture 106 with a finger nail so as to drop the first lens 108 and/or the second lens 110 out of the lens receiver(s) into a safely planned secure location for cleaning or replacement.

As described above, the second lens 110 is the closest to the archer's eye. In some embodiments, the first lens 108 is a clarifier lens and the second lens 110 is a verifier lens. When the verifier lens and the clarifier lens are used together, the appearance of the target and pin clarity can be fine-tuned all at one time, e.g., instead of separately. The verifier powers and clarifier powers interact with each other, creating the ability to micro adjust how clear the archer wants the target and the pins to appear, versus only being able to clear up the target or the pins. In some embodiments, the verifier lens has six powers available depending upon an archer's eyes sight condition (e.g., diopter +0.50, +0.75, +1.00, +1.25, +1.50, +1.75, and so on). In some embodiments, the clarifier lens has five powers available (e.g., diopter −0.5, −1.0, −1.5, −2.0, −3.0). Thus, the verifier lens can be configured to clear up the sight pins, and the clarifier lens (e.g., when using a scope lens) can be configured to keep the same target clarity, producing a clear sight pins picture and a clear target picture. The peep sight assembly 100 is configured to include both lenses in the same assembly, allowing for excellent sight and target clarity. As described, the verifier lens and clarifier lens can have opposite diopters and lens curvatures. The reduced cross-sectional area 164 can be selected to position the verifier lens, the lens insulator and the clarifier lens so that the space between the lenses allows both lenses to work together and create sight and target clarity.

In some embodiments, the first lens 108 is a verifier lens and the second lens 110 is a clarifier lens. In another embodiment, the peep sight assembly 100 can be used with no lenses, one clarifier lens, or one verifier lens. In some embodiments, the peep sight assembly 100 can also be used with two verifier lenses, two clarifier lenses, and so forth. For example, the first lens 108 can be a verifier lens and the second lens 110 can also be a verifier lens. In another example, the first lens 108 can be a clarifier lens and the second lens 110 can also be a clarifier lens. The use of different types and combinations of lens allows the operator to adjust the optical power of the peep sight assembly 100.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A peep sight assembly for a bowstring of an archery bow, the peep sight comprising:
a housing having a first end and an opposing second end, the housing configured to be securable to a bowstring of an archery bow, the housing defining a passage therethrough, the passage having
first threads at the first end of the housing, and
second threads at the second end of the housing;
a first aperture having a first end and an opposing second end, the first aperture configured to be connected to the first end of the housing, the first aperture defining a passage therethrough, the first aperture including
first threads at the first end of the first aperture for being received by the first threads at the first end of the housing to connect the first aperture to the housing,
a first lens receiver at the first end of the first aperture for receiving a first lens, and
an annular finger grip at the second end of the first aperture; and
a second aperture having a first end and an opposing second end, the second aperture configured to be connected to the second end of the housing, the second aperture defining a passage therethrough, the second aperture including
second threads at the first end of the second aperture for being received by the second threads at the second end of the housing to connect the second aperture to the housing,
a second lens receiver at the first end of the second aperture for receiving a second lens, and
an annular finger grip at the second end of the second aperture.

2. The peep sight assembly as recited in claim 1, where the first threads at the first end of the housing are first internal threads and the first threads at the first end of the first aperture are first external threads.

3. The peep sight assembly as recited in claim 1, wherein the housing comprises a plurality of external grooves for seating the housing between a separated section of the bowstring of the archery bow for securing the housing to the bowstring.

4. The peep sight assembly as recited in claim 1, wherein the passage defined through the housing has a reduced cross-sectional area between the first threads and the second threads, and the peep sight assembly further comprises a lens insulator configured to be positioned between the first aperture and the second aperture for securing at least one of the first lens or the second lens with respect to the first aperture or the second aperture, respectively.

5. The peep sight assembly as recited in claim 1, wherein at least one of the first lens or the second lens comprises a verifier lens or a clarifier lens.

6. The peep sight assembly as recited in claim 1, wherein the first lens and the second lens both comprise a set of verifier lenses or a set of clarifier lenses.

7. A peep sight assembly for a bowstring of an archery bow, the peep sight comprising:
a housing having a first end and an opposing second end, the housing configured to be securable to a bowstring of an archery bow, the housing defining a passage therethrough, the passage having
first internal threads at the first end of the housing, and
second internal threads at the second end of the housing;
a first aperture having a first end and an opposing second end, the first aperture configured to be connected to the first end of the housing, the first aperture defining a passage therethrough, the first aperture including
first external threads at the first end of the first aperture for being received by the first internal threads at the first end of the housing to connect the first aperture to the housing,
a first lens receiver at the first end of the first aperture for receiving a first lens, and
an annular finger grip at the second end of the first aperture; and
a second aperture having a first end and an opposing second end, the second aperture configured to be connected to the second end of the housing, the second aperture defining a passage therethrough, the second aperture including
second external threads at the first end of the second aperture for being received by the second internal threads at the second end of the housing to connect the second aperture to the housing,
a second lens receiver at the first end of the second aperture for receiving a second lens, and
an annular finger grip at the second end of the second aperture.

8. The peep sight assembly as recited in claim 7, wherein the housing comprises a plurality of external grooves for seating the housing between a separated section of the bowstring of the archery bow for securing the housing to the bowstring.

9. The peep sight assembly as recited in claim 7, wherein the passage defined through the housing has a reduced cross-sectional area between the first internal threads and the second internal threads, and the peep sight assembly further comprises a lens insulator configured to be positioned between the first aperture and the second aperture for securing at least one of the first lens or the second lens with respect to the first aperture or the second aperture, respectively.

10. The peep sight assembly as recited in claim 7, wherein at least one of the first lens or the second lens comprises a verifier lens or a clarifier lens.

11. The peep sight assembly as recited in claim 7, wherein the first lens and the second lens both comprise a set of verifier lenses or a set of clarifier lenses.

12. A peep sight assembly for a bowstring of an archery bow, the peep sight comprising:
a housing having a first end and an opposing second end, the housing configured to be securable to a bowstring of an archery bow, the housing defining a passage therethrough;
a first aperture having a first end and an opposing second end, the first aperture configured to be connected to the first end of the housing, the first aperture defining a passage therethrough, the first aperture configured to be received at the first end of the housing to connect the first aperture to the housing so that a first lens can be retained at the first end of the housing; and
a second aperture having a first end and an opposing second end, the second aperture configured to be connected to the second end of the housing, the second aperture defining a passage therethrough, the second aperture configured to be received at the second end of the housing to connect the second aperture to the housing so that a second lens can be retained at the second end of the housing.

13. The peep sight assembly as recited in claim 12, wherein the housing has first threads at the first end of the housing, and the first aperture has first threads at the first end of the first aperture for being received by the first threads at the first end of the housing to connect the first aperture to the housing.

14. The peep sight assembly as recited in claim 13, where the first threads at the first end of the housing are first internal threads and the first threads at the first end of the first aperture are first external threads.

15. The peep sight assembly as recited in claim 12, further comprising a first lens receiver at the first end of the first aperture for receiving the first lens.

16. The peep sight assembly as recited in claim 12, further comprising an annular finger grip at the second end of the first aperture.

17. The peep sight assembly as recited in claim 12, wherein the housing comprises a plurality of external grooves for seating the housing between a separated section of the bowstring of the archery bow for securing the housing to the bowstring.

18. The peep sight assembly as recited in claim 12, wherein the passage defined through the housing has a reduced cross-sectional area between the first end and the second end of the housing, and the peep sight assembly further comprises a lens insulator configured to be positioned between the first aperture and the second aperture for securing at least one of the first lens or the second lens with respect to the first aperture or the second aperture, respectively.

19. The peep sight assembly as recited in claim 12, wherein at least one of the first lens or the second lens comprises a verifier lens or a clarifier lens.

20. The peep sight assembly as recited in claim 12, wherein the first lens and the second lens both comprise a set of verifier lenses or a set of clarifier lenses.
